(19) United States
(12) Patent Application Publication
(10) Pub. No.: US 2014/0029408 A1
(43) Pub. Date: Jan. 30, 2014

(54) TRANSMISSION-SIDE COMMUNICATION APPARATUS AND RETRANMSISSION CONTROL METHOD

(71) Applicant: Atsushi Yamamoto, Kikuchi-gun Kumamoto (JP)

(72) Inventor: Atsushi Yamamoto, Kikuchi-gun Kumamoto (JP)

(73) Assignee: KYOCERA CORPORATION, Kyoto (JP)

(21) Appl. No.: 14/111,164

(22) PCT Filed: Apr. 6, 2012
(86) PCT No.: PCT/JP2012/059553

§ 371 Date: Oct. 10, 2013

(30) Foreign Application Priority Data
Apr. 12, 2011 (JP) 2011-088563

(51) Int. Cl. H04L 1/18

(52) U.S. Cl. CPC H04L 1/1867
USPC 370/216

(57) ABSTRACT

A retransmission control method of a transmission-side communication apparatus, which transmits a packet to a reception-side communication apparatus in a radio communication system that supports adaptive modulation and coding (AMC) and hybrid automatic retransmission control (HARQ), comprises: a step (S110 to S125) of transmitting an initially transmitted packet to the reception-side communication apparatus by using a first MCS; and a step (Step S155) of transmitting a new initially transmitted packet to the reception-side communication apparatus by using a second MCS, instead of transmission of a retransmitted packet that is combined with the initially transmitted packet in the reception-side communication apparatus, when the second MCS different from the first MCS is used at the time of retransmission (step s150; NO), the new initially transmitted packet including retransmission data to be transmitted through the retransmitted packet.

### TECHNICAL FIELD

The present invention relates to a transmission-side communication apparatus and a retransmission control method of a radio communication system that supports adaptive modulation and coding and hybrid automatic retransmission control.

### BACKGROUND ART

Conventionally, there has been known adaptive modulation and coding (AMC) as one of technologies capable of improving throughput in radio communication. In the AMC, a radio communication apparatus of a transmission side (hereinafter, a “transmission-side communication apparatus”) adaptively selects a modulation and coding scheme (MCS), which is determined by a combination of a modulation scheme and a coding rate, on the basis of the state of a radio link (hereinafter, a “radio state”) between the transmission-side communication apparatus and a radio communication apparatus of a reception side (hereinafter, a “reception-side communication apparatus”).

Furthermore, a radio communication system uses a hybrid automatic repeat request (HARQ) in order to improve throughput by efficiently recovering a transmission error. In a chase combining (CC) scheme that is one scheme of the HARQ, a packet having the same content as that of a packet initially transmitted (hereinafter, an “initially transmitted packet”) is transmitted from a transmission-side communication apparatus to a reception-side communication apparatus as a retransmitted packet. The reception-side communication apparatus combines the received retransmitted packet with an initially transmitted packet which has been held in a reception buffer, by a predetermined method, so that it is possible to reduce a packet error rate, resulting in an increase in the probability of succeeding in packet decoding.

In a conventional radio communication system that supports the HARQ of the CC scheme, when MCS used in the transmission of an initially transmitted packet is different from MCS used in the transmission of a retransmitted packet, since there is a limitation that it is not possible to perform a combination process of the initially transmitted packet and the retransmitted packet, it is general that a transmission-side communication apparatus transmits the retransmitted packet by using MCS, which is selected at the time of initial transmission, at the time of retransmission.

On the other hand, Patent Literature 1 discloses, in HARQ, a radio communication system capable of using MCS, which is different from MCS selected at the time of initial transmission, at the time of retransmission. In the radio communication system disclosed in Patent Literature 1, when the MCS at the time of retransmission is changed from the MCS at the time of initial transmission due to a change in a radio state, a transmission-side communication apparatus transmits the whole or a part of an initially transmitted packet as a retransmitted packet, and a reception-side communication apparatus partially combines the received retransmitted packet with the initially transmitted packet.

### PRIOR ART DOCUMENT

### Patent Document

[PLT 1] Japanese Unexamined Patent Application Publication No. 2003-198429

### SUMMARY OF THE INVENTION

In the conventional radio communication system that supports the HARQ of the CC scheme, when a radio state at the time of retransmission is significantly different from a radio state at the time of initial transmission, inappropriate MCS may be used at the time of retransmission. Particularly, in the case in which the radio state at the time of retransmission has deteriorated as compared with the radio state at the time of initial transmission, even when a retransmitted packet is transmitted using MCS the same as MCS at the time of initial transmission, since an error rate of the retransmitted packet is high, an improvement effect of the error rate through a combination process is reduced.

Furthermore, due to the reason such as an error included in reception state information that is fed back from the reception-side communication apparatus to the transmission-side communication apparatus, the transmission-side communication apparatus may make a mistake in the selection of MCS. In the conventional radio communication system that supports the HARQ of the CC scheme, when there has been a selection mistake in the selection of the MCS at the time of initial transmission, the mistaken MCS should be used also at the time of retransmission, resulting in the deterioration of system performance.

On the other hand, since the radio communication system disclosed in Patent Literature 1 is able to use MCS, which is different from MCS at the time of initial transmission, at the time of retransmission, it is possible to avoid the problem of the conventional radio communication system that supports the HARQ of the CC scheme. However, it is necessary to provide the reception-side communication apparatus with a special mechanism for a partial combination process. That is, it is necessary to change the configuration of the conventional reception-side communication apparatus, resulting in the problem that introduction cost is high.

Therefore, an object of the present invention is to provide a transmission-side communication apparatus and a retransmission control method, by which it is possible to use a modulation and coding scheme (MCS), which is different from MCS at the time of initial transmission, also at the time of retransmission without a change in the configuration of the conventional reception-side communication apparatus.

To solve the above problems, the present invention includes the following characteristics.

Firstly, an aspect of a transmission-side communication apparatus according to the present invention is summarized as a transmission-side communication apparatus (a transmission-side communication apparatus 100), which transmits a packet to a reception-side communication apparatus (a reception-side communication apparatus 200) in a radio communication system (a radio communication system 1) that supports adaptive modulation and coding and hybrid automatic retransmission control, comprising: a transmission unit (a transmission unit 110T) that transmits an initially transmitted packet and a retransmitted packet to the reception-side communication apparatus, the retransmitted packet being combined with the initially transmitted packet in the reception-side communication apparatus; and a control unit (a control unit 120) that controls, when a modulation and coding scheme different from the modulation and coding scheme used at the time of transmission of the initially transmitted packet is used at the time of retransmission, the transmission unit to transmit, instead of transmitting the retransmitted packet, a new initially transmitted packet including retransmission data to be transmitted, by using the different modulation and coding scheme, through the retransmitted packet, to the reception-side communication apparatus.

According to the transmission-side communication apparatus, when a modulation and coding scheme, which is different from a modulation and coding scheme used at the time of transmission of the initially transmitted packet, is used at the time of retransmission, instead of the retransmitted packet being transmitted, a new initially transmitted packet including retransmission data to be transmitted through the retransmitted packet is transmitted by using the different modulation and coding scheme. In this way, it is possible to transmit the retransmission data by an appropriate modulation and coding scheme and the reception-side communication apparatus needs not to perform the partial combination process disclosed in Patent Literature 1. Consequently, the transmission-side communication apparatus having the characteristic is able to use a modulation and coding scheme (MCS), which is different from that at the time of initial transmission, at the time of retransmission without a change in the configuration of a conventional reception-side communication apparatus.

Another aspect of the transmission-side communication apparatus according to the present invention is summarized as, in the transmission-side communication apparatus according to the above aspect, when the different modulation and coding scheme is used at the time of retransmission due to deterioration of a radio state between the transmission-side communication apparatus and the reception-side communication apparatus, the control unit controls the transmission unit to transmit, instead of transmitting the retransmitted packet, the new initially transmitted packet to the reception-side communication apparatus by using the different modulation and coding scheme.

The other aspect of the transmission-side communication apparatus according to the present invention is summarized as, in the transmission-side communication apparatus according to the above aspect, the transmission unit comprises: a first retransmission queue unit (a CC retransmission queue 113) that holds the retransmission data to be transmitted through the retransmitted packet; a second retransmission queue unit (a PDU retransmission queue 112); and a transmission queue unit (a transmission queue 111) that holds data to be newly transmitted, the control unit controls the transmission unit to include the retransmission data held in the first retransmission queue unit into the retransmitted packet and to transmit the retransmitted packet when a modulation and coding scheme, which is equal to the modulation and coding scheme used at the time of transmission of the initially transmitted packet, is used at the time of retransmission, and the control unit moves the retransmission data held in the first retransmission queue unit to the second retransmission queue unit and then controls the transmission unit to include the retransmission data into the new initially transmitted packet in sequence of priority of retransmission data held in the second retransmission queue unit and data held in the transmission queue unit, to transmit the new initially transmitted packet when the different modulation and coding scheme is used at the time of retransmission.

An aspect of a retransmission control method according to the present invention is summarized as a retransmission control method of a transmission-side communication apparatus, which transmits a packet to a reception-side communication apparatus in a radio communication system that supports adaptive modulation and coding and hybrid automatic retransmission control, comprising: a step of transmitting an initially transmitted packet to the reception-side communication apparatus by using a first modulation and coding scheme; and a step of transmitting a new initially transmitted packet to the reception-side communication apparatus by using a second modulation and coding scheme, instead of transmission of a retransmitted packet that is combined with the initially transmitted packet in the reception-side communication apparatus, when the second modulation and coding scheme different from the first modulation and coding scheme is used at the time of retransmission, the new initially transmitted packet including retransmission data to be transmitted through the retransmitted packet.

Another aspect of the retransmission control method according to the present invention is summarized as, in the retransmission control method according to the above aspect, in the step of transmitting the new initially transmitted packet, when the second modulation and coding scheme is used at the time of retransmission due to deterioration of a radio state between the transmission-side communication apparatus and the reception-side communication apparatus, the new initially transmitted packet is transmitted, instead of the retransmitted packet being transmitted, to the reception-side communication apparatus by using the second modulation and coding scheme.

The other aspect of the retransmission control method according to the present invention is summarized as, in the retransmission control method according to the above aspect, the transmission-side communication apparatus comprises: a first retransmission queue unit that holds the retransmission data to be transmitted through the retransmitted packet; a second retransmission queue unit; and a transmission queue unit that holds data to be newly transmitted, and the step of transmitting the new initially transmitted packet comprises: a step of moving the retransmission data held in the first retransmission queue unit to the second retransmission queue unit, and a step of including the retransmission data into the new initially transmitted packet in sequence of priority of retransmission data held in the second retransmission queue unit and data held in the transmission queue unit.

### BRIEF DESCRIPTION OF THE DRAWINGS

FIG. 1 is a diagram illustrating the entire schematic configuration of a radio communication system according to an embodiment of the present invention.

FIG. 2 is a block diagram illustrating a detailed configuration of a transmission-side communication apparatus according to the embodiment of the present invention.

FIG. 3 is a diagram illustrating a relation between a PHY burst and MAC PDU.

FIG. 4 is a block diagram illustrating a detailed configuration of a reception-side communication apparatus according to the embodiment of the present invention.

FIG. 5 is a flowchart illustrating an operation of the transmission-side communication apparatus according to the embodiment of the present invention.

FIG. 6 is a flowchart illustrating an operation of the reception-side communication apparatus according to the embodiment of the present invention.

### DESCRIPTION OF THE EMBODIMENT

With reference to the drawings, an embodiment of the present invention will be described in sequence of (1) Overview of radio communication system, (2) Detailed configuration of radio communication system, (3) Operation of radio communication system, (4) Effect of embodiment, and (5) Other embodiments. It is to be noted that the same or similar reference numerals are applied to the same or similar parts through the drawings in the following embodiments.

### (1) Overview of Radio Communication System

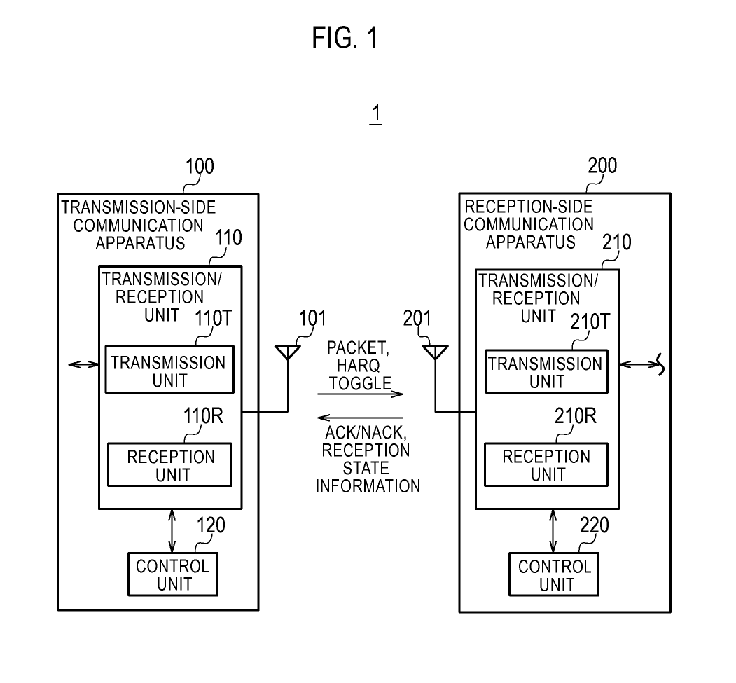

FIG. 1 is an entire schematic configuration diagram of a radio communication system 1 according to the present embodiment. The radio communication system 1 supports the aforementioned AMC and the HARQ of the aforementioned CC scheme.

As illustrated in FIG. 1, the radio communication system 1 includes a transmission-side communication apparatus 100 and a reception-side communication apparatus 200. For example, the transmission-side communication apparatus 100 is a base station and the reception-side communication apparatus 200 is a radio terminal.

The transmission-side communication apparatus 100 includes an antenna 101, a transmission/reception unit 110 that transmits and receives a radio signal via the antenna 101, and a control unit 120 that controls the transmission/reception unit 110. The transmission/reception unit 110 includes a transmission unit 110T and a reception unit 110R.

The reception-side communication apparatus 200 includes an antenna 201, a transmission/reception unit 210 that transmits and receives a radio signal via the antenna 201, and a control unit 220 that controls the transmission/reception unit 210. The transmission/reception unit 210 includes a transmission unit 210T and a reception unit 210R.

In the transmission-side communication apparatus 100, the transmission unit 110T transmits a packet. Furthermore, the transmission unit 110T transmits a HARQ toggle, which is used to notify the reception-side communication apparatus 200 of whether the packet is an initially transmitted packet or a retransmitted packet, as additional information when transmitting the packet. The HARQ toggle is a 1-bit flag, and the transmission-side communication apparatus 100 inverts a value of the HARQ toggle at the time of transmission of an initially transmitted packet, and maintains the value of the HARQ toggle at the time of transmission of a retransmitted packet.

In the reception-side communication apparatus 200, the reception unit 210R receives the packet transmitted by the transmission-side communication apparatus 100, and decodes the received packet. When a retransmitted packet has been received, that is, when a packet with the value of the HARQ toggle maintained has been received, the reception unit 210R combines the retransmitted packet with a previously received packet, which has been held in a reception buffer of the reception unit 210R, by a predetermined method, and decodes the combined packet. On the other hand, when an initially transmitted packet has been received, that is, when a packet with the value of the HARQ toggle inverted has been received, the reception unit 210R resets the reception buffer of the reception unit 210R and decodes the initially transmitted packet. Furthermore, the control unit 220 controls the transmission unit 210T so as to feed back an acknowledge response (ACK) to the transmission-side communication apparatus 100 when the reception unit 210R has succeeded in the decoding, and feed back a negative acknowledge response (NACK) to the transmission-side communication apparatus 100 when the reception unit 210R has failed in the decoding.

Furthermore, in the reception-side communication apparatus 200, the reception unit 210R measures the reception state (SINR and the like) of a radio signal that is received from the transmission-side communication apparatus 100. The control unit 220 controls the transmission unit 210T to periodically feed back reception state information indicating a result of the measurement to the transmission-side communication apparatus 100. Such reception state information may be called CQI (Channel Quality Indicator).

In the transmission-side communication apparatus 100, the reception unit 110R receives the ACK/NACK and the reception state information from the reception-side communication apparatus 200. The control unit 120 controls the transmission unit 110T to perform a retransmission process in response to the ACK/NACK, which has been received in the reception unit 110R, according to a HARQ procedure. Furthermore, the control unit 120 sets MCS in the transmission unit 110T in response to the reception state information, which has been received in the reception unit 110R, according to an AMC procedure, wherein the MCS is determined through a combination of a modulation scheme and a coding rate.

In the transmission-side communication apparatus 100 of the radio communication system 1 configured as above, the transmission unit 110T transmits an initially transmitted packet and a retransmitted packet to the reception-side communication apparatus 200, wherein the retransmitted packet is combined with the initially transmitted packet in the reception-side communication apparatus 200. When MCS, which is different from MCS used at the time of transmission of the initially transmitted packet, is used at the time of retransmission, the control unit 120 controls the transmission unit 110T to transmit, instead of transmitting the retransmitted packet, a new initially transmitted packet including retransmission data to be transmitted through the retransmitted packet, to the reception-side communication apparatus 200 by using the different MCS.

Such retransmission control is performed, so that it is possible to transmit retransmission data to the reception-side communication apparatus 200 by using appropriate MCS. Furthermore, when the retransmission data is included in the initially transmitted packet, it becomes unnecessary for the reception-side communication apparatus 200 to perform a special combination process because the received initially transmitted packet will not be combined with a packet received before. That is, since it is not necessary to change the configuration of the reception-side communication apparatus 200, it is possible to keep an introduction cost at low.

### (2) Detailed Configuration of Radio Communication System

Next, a detailed configuration of the radio communication system 1 according to the present embodiment will be described in sequence of (2.1) Detailed configuration of transmission-side communication apparatus and (2.2) Detailed configuration of reception-side communication apparatus.

### (2.1) Detailed Configuration of Transmission-Side Communication Apparatus

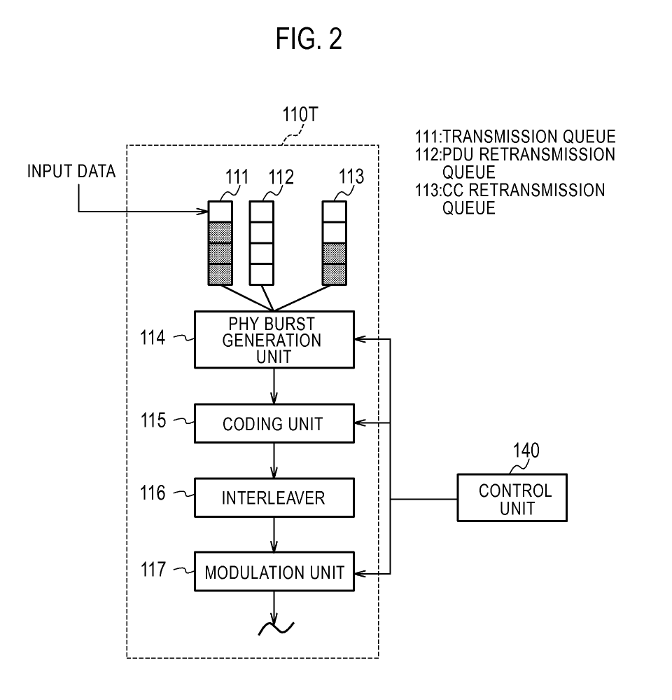

FIG. 2 is a block diagram illustrating a detailed configuration of the transmission-side communication apparatus 100 according to the present embodiment, specifically, a block diagram illustrating an internal configuration of the transmission unit 110T of the transmission-side communication apparatus 100. In addition, in FIG. 2, a high frequency (RF) processing block such as an up-converter or a power amplifier is not illustrated.

As illustrated in FIG. 2, the transmission unit 110T of the transmission-side communication apparatus 100 includes a transmission queue 111, a PDU (Protocol Data Unit) retransmission queue 112, a CC retransmission queue 113, a PHY (PHYsical Layer) burst generation unit 114, a coding unit 115, an interleaver 116, and a modulation unit 117.

The transmission queue 111 holds MAC PDU that is a unit of data that is input from a MAC layer which is an upper layer to the transmission unit 110T. Each of the PDU retransmission queue 112 and the CC retransmission queue 113 holds transmitted MAC PDU for the purpose of retransmission. The PDU retransmission queue 112 holds MAC PDU (retransmission data) for retransmission included in an initially transmitted packet, and the CC retransmission queue 113 holds MAC PDU (retransmission data) for retransmission included in a retransmitted packet. In other words, the PDU retransmission queue 112 holds MAC PDU for retransmission, which is not subject to a combination process in the reception-side communication apparatus 200, and the CC retransmission queue 113 holds MAC PDU for retransmission, which is subject to the combination process in the reception-side communication apparatus 200.

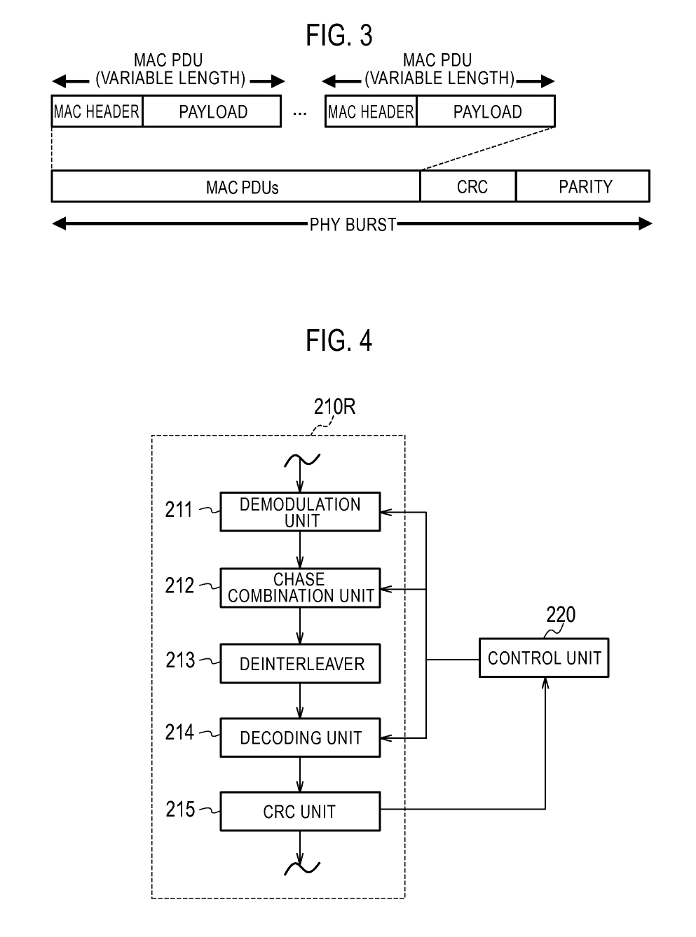

The PHY burst generation unit 114 extracts a plurality of MAC PDUs from the transmission queue 111, the PDU retransmission queue 112, and the CC retransmission queue 113, and creates a PHY burst as illustrated in FIG. 3. FIG. 3 is a diagram illustrating a relation between the PHY burst and the MAC PDU. As illustrated in FIG. 3, the PHY burst may include a plurality of MAC PDUs having variable lengths, each of which includes a MAC header and a payload, wherein a CRC (Cyclic Redundancy Check) code for bit error check and a parity for adjusting the size of the PHY burst are positioned next to the MAC PDU. In addition, the PHY burst becomes a packet that is subject to processing including coding, modulation and the like and is transmitted to the reception-side communication apparatus 200.

The coding unit 115 receives the PHY burst from the PHY burst generation unit 114. In order that the input PHY burst is imparted with an error correction function, the coding unit 115, for example, performs coding by using a turbo code and the like. In addition, a coding rate in the coding is determined in response to the MCS selected by a control unit 140.

The interleaver 116 receives a coding bit sequence from the coding unit 115. The interleaver 116 changes (mixes) an order of the input bit sequence to have tolerance against a burst error.

The modulation unit 117 receives a bit sequence from the interleaver 116. The modulation unit 117 modulates the input bit sequence with a modulation scheme such as BPSK (Binary Phase Shift Keying), QPSK (Quadrature Phase Shift Keying), or QAM (Quadrature Amplitude Modulation). In addition, the modulation scheme is determined in response to the MCS selected by the control unit 140.

A bit sequence (a packet) that is output from the modulation unit 117 is converted into a radio signal by an RF processing block (not illustrated), and is transmitted from the antenna 101 illustrated in FIG. 1.

### (2.2) Detailed Configuration of Reception-Side Communication Apparatus

FIG. 4 is a block diagram illustrating a detailed configuration of the reception-side communication apparatus 200 according to the present embodiment, specifically, a block diagram illustrating an internal configuration of the reception unit 210R of the reception-side communication apparatus 200. In addition, in FIG. 4, an RF processing block such as a low noise amplifier or a down-converter is not illustrated.

As illustrated in FIG. 4, the reception unit 210R of the reception-side communication apparatus 200 includes a demodulation unit 211, a chase combination unit 212, a deinterleaver 213, a decoding unit 214, and a CRC unit 215.

The radio signal output from the antenna 201 illustrated in FIG. 1 is converted to a baseband signal by an RF processing block (not illustrated), and the baseband signal is input to the demodulation unit 211.

The demodulation unit 211 demodulates an input signal and outputs an LLR (Log likelihood Ratio) value. The LLR value is obtained by performing soft decision for each demodulated code bit.

The chase combination unit 212 receives the LLR value from the demodulation unit 211. The chase combination unit 212 combines an LLR value of a packet received previous time and held in a buffer of the chase combination unit 212 with an LLR value of a packet received this time, thereby improving the reliability of each bit of the packet.

The deinterleaver 213 receives a bit sequence from the chase combination unit 212. The deinterleaver 213 performs a process (inverse mixing) of returning an order of the bit sequence to an original order.

The decoding unit 214 receives a bit sequence from the deinterleaver 213. The decoding unit 214 decodes the bit sequence and outputs a PHY burst.

The CRC unit 215 receives the PHY burst from the decoding unit 214. The CRC unit 215 performs error detection using a CRC code included in the PHY burst, and notifies the control unit 220 of a result of the error detection.

The control unit 220 controls ACK to be transmitted when the control unit 220 is notified that no error is detected, and controls NACK to be transmitted when the control unit 220 is notified that any errors are detected.

### (3) Operation of Radio Communication System

Next, an operation of the radio communication system 1 according to the present embodiment will be described in sequence of (3.1) Operation of transmission-side communication apparatus and (3.2) Operation of reception-side communication apparatus.

### (3.1) Operation of Transmission-Side Communication Apparatus

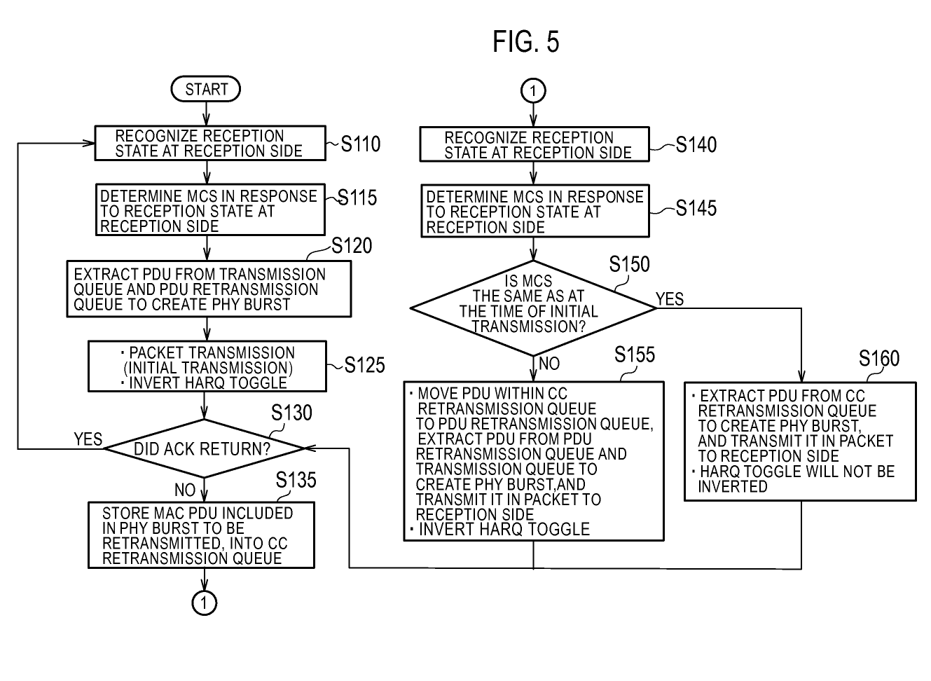

FIG. 5 is a flowchart illustrating the operation of the transmission-side communication apparatus 100 according to the present embodiment.

As illustrated in FIG. 5, in step S110, the control unit 120 recognizes a reception state of the reception-side communication apparatus 200 on the basis of reception state information (CQI) received in the reception unit 11OR from the reception-side communication apparatus 200.

In step S115, the control unit 120 determines MCS to be set in the transmission unit 110T among a plurality of MCSs in response to the reception state of the reception-side communication apparatus 200.

In step S120, the control unit 120 controls the PHY burst generation unit 114 to extract a sufficient number of MAC PDUs, which can be stored in a PHY burst, from the transmission queue 111 in order to generate the PHY burst.

In step S125, the PHY burst generation unit 114, the coding unit 115, the interleaver 116, and the modulation unit 117 respectively perform coding, interleaving, and modulation with respect to the PHY burst, and output the PHY burst to the antenna 101. At this time, in order to inform the reception-side communication apparatus 200 of the fact that an initially transmitted packet has been transmitted, the control unit 120 controls a value of the HARQ toggle to be inverted and transmitted together with a packet.

In step S130, the control unit 120 transmits a packet and then waits for ACK from the reception-side communication apparatus 200. Then, when the ACK has been received, the control unit 120 returns the procedure to step S110. On the other hand, when it has been not possible to receive the ACK within a timeout time or when NACK has been received from the reception-side communication apparatus 200, the control unit 120 shifts to a retransmission process after step S135.

In step S135, the control unit 120 moves each MAC PDU included in a PHY burst to be retransmitted from the transmission queue 111 to the CC retransmission queue 113 at the time of start of the retransmission process.

In step S140, the control unit 120 recognizes a current reception state of the reception-side communication apparatus 200 on the basis of reception state information (CQI) newly received in the reception unit 110R from the reception-side communication apparatus 200.

In step S145, the control unit 120 determines MCS to be set in the transmission unit 110T among a plurality of MCSs in response to the reception state of the reception-side communication apparatus 200.

In step S150, the control unit 120 determines whether the MCS determined in step S145 is the same as the MCS at the time of initial transmission determined in step S115. Then, when the MCS determined in step S145 is the same as the MCS at the time of initial transmission determined in step S115, the control unit 120 shifts the procedure to step S160. On the other hand, when the MCS determined in step S145 is different from the MCS at the time of initial transmission determined in step S115, the control unit 120 shifts the procedure to step S155.

Instep S155, the control unit 120 moves the MAC PDUs in the CC retransmission queue 113 to the PDU retransmission queue 112 in order to generate a new PHY burst. Then, the control unit 120 extracts the MAC PDU in sequence of priority of the PDU retransmission queue 112 and the transmission queue 111, and controls the PHY burst generation unit 114 to generate the new PHY burst. Then, the PHY burst generation unit 114, the coding unit 115, the interleaver 116, and the modulation unit 117 respectively perform coding, interleaving, and modulation with respect to the PHY burst, and output the PHY burst to the antenna 101. At this time, in order to inform the reception-side communication apparatus 200 of the fact that an initially transmitted packet has been transmitted, the control unit 120 controls a value of the HARQ toggle to be inverted and transmitted together with a packet.

Meanwhile, in step S160, similarly to a normal CC procedure, in order to generate the completely same PHY burst as that at the time of initial transmission, the control unit 120 controls the PHY burst generation unit 114 to extract MAC PDUs from the CC retransmission queue 113 by the same number of MAC PDUs at the time of initial transmission, and to generate the PHY burst. Then, the PHY burst generation unit 114, the coding unit 115, the interleaver 116, and the modulation unit 117 respectively perform coding, interleaving, and modulation with respect to the PHY burst, and output the PHY burst to the antenna 101. At this time, in order to inform the reception-side communication apparatus 200 of the fact that a retransmitted packet has been transmitted, the control unit 120 controls the value of the HARQ toggle to be maintained and transmitted together with a packet.

After step S155 and step S160, the control unit 120 returns to the process of step S130, that is, returns to the state of waiting the ACK from the reception-side communication apparatus 200.

### (3.2) Operation of Reception-Side Communication Apparatus

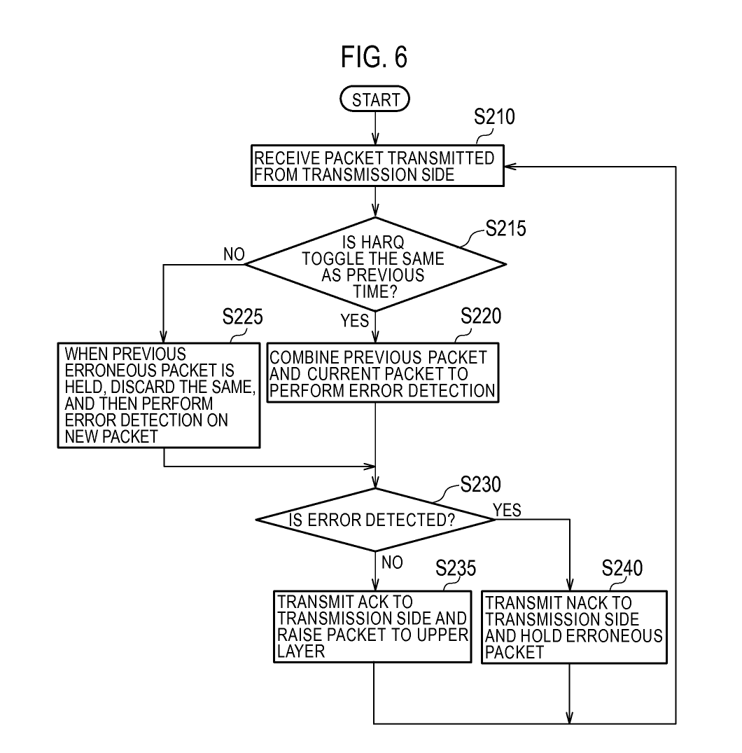

FIG. 6 is a flowchart illustrating the operation of the reception-side communication apparatus 200 according to the present embodiment.

As illustrated in FIG. 6, in step S210, the demodulation unit 211 demodulates a signal input from the antenna 201, and acquires LLR values of each bit.

In step S215, the control unit 220 recognizes the value of the HARQ toggle included in the received data (packet) and determines whether the value is the same as a previous value. Then, when the value of the HARQ toggle included in the received data is the same as the previous value, the control unit 220 shifts the procedure to step S220. On the other hand, when the value of the HARQ toggle included in the received data is different from the previous value, the control unit 220 shifts the procedure to step S225.

In step S220, the control unit 220 recognizes that the received packet is a retransmitted packet, and controls the chase combination unit 212 to combine LLR values of a packet held previous time and the packet received this time with each other. Then, the deinterleaver 213, the decoding unit 214, and the CRC unit 215 perform deinterleaving, decoding, and error detection using a CRC code, respectively.

In step S225, the control unit 220 recognizes that the received packet is an initially transmitted packet, and controls the chase combination unit 212 to discard a previous packet when the previous packet has been held in the buffer. That is, the initially transmitted packet is not subject to a combination process. Then, the deinterleaver 213, the decoding unit 214, and the CRC unit 215 perform deinterleaving, decoding, and error detection using a CRC code, respectively.

In step S230, the control unit 220 recognizes whether an error has been detected. Then, when the error has been detected, the control unit 220 shifts the procedure to step S240. On the other hand, when no error has been detected, the control unit 220 shifts the procedure to step S235.

In step S235, the control unit 220 controls the transmission unit 210T to transmit ACK to the transmission-side communication apparatus 100, and outputs a plurality of restored MAC PDUs to an upper layer.

In step S240, the control unit 220 controls the transmission unit 210T to transmit NACK to the transmission-side communication apparatus 100, and controls the chase combination unit 212 to hold an LLR value of an erroneous packet in the reception buffer.

In addition, since an arrival order of the MAC PDUs may be reversed due to a factor such as waiting for retransmission, the arrival order is changed to an original order by PDU arrival order control of the upper layer.

### (4) Effect of Embodiments

As described above, when MCS, which is different from MCS used at the time of transmission of an initially transmitted packet, is used at the time of retransmission, the transmission-side communication apparatus 100 according to the present embodiment transmits, instead of transmitting the retransmitted packet, an initially transmitted packet including retransmission data to be transmitted through a retransmitted packet, to the reception-side communication apparatus 200 by using the different MCS.

Such retransmission control is performed, so that it is possible to transmit retransmission data to the reception-side communication apparatus 200 by using appropriate MCS. Furthermore, when the retransmission data is included in the initially transmitted packet, it becomes unnecessary for the reception-side communication apparatus 200 to perform a special combination process because the received initially transmitted packet will not be combined with a packet received before. That is, since it is not necessary to change the configuration of the reception-side communication apparatus 200, it is possible to keep an introduction cost at low. Particularly, when the transmission-side communication apparatus 100 is a base station and the reception-side communication apparatus 200 is a radio terminal, since it is sufficient if only the configuration of the base station side is changed, it is possible to significantly lower the introduction cost.

Moreover, when MCS at the time of retransmission is higher (a higher data rate) than MCS at the time of initial transmission, since it is possible to put MAC PDUs more than MAC PDUs of the PDU retransmission queue into the PHY burst, it is expectable to improve transmission efficiency.

### (5) Other Embodiments

As described above, the present invention has been described with the embodiment. However, it should not be understood that those descriptions and drawings constituting a part of the present disclosure limit the present invention. From this disclosure, a variety of alternate embodiments, examples, and applicable techniques will become apparent to one skilled in the art.

In the aforementioned embodiment, since a radio state at the time of retransmission becomes better than a radio state at the time of initial transmission, even when MCS at the time of initial transmission is different from MCS at the time of retransmission, an initially transmitted packet, instead of a retransmitted packet, is transmitted. However, in the case in which the radio state at the time of retransmission becomes better than the radio state at the time of initial transmission, since MCS with a bit rate higher than that at the time of initial transmission is selected at the time of retransmission and a combination process effect is high, it may be possible to use a method in which MCS at the time of retransmission is set the same as that at the time of initial transmission and an error is quickly recovered through a normal combination process in such a case.

On the other hand, in the case in which the radio state at the time of retransmission becomes worse than the radio state at the time of initial transmission, since MCS with a bit rate lower than that at the time of initial transmission is selected at the time of retransmission and a combination process effect is low, it is preferable to use a method in which MCS at the time of retransmission is differed from that at the time of initial transmission, an initially transmitted packet is transmitted instead of a retransmitted packet, and a combination process in the reception-side communication apparatus 200 is stopped in such a case.

The aforementioned embodiment described the case in which the transmission-side communication apparatus 100 is a base station and the reception-side communication apparatus 200 is a radio terminal. However, the transmission-side communication apparatus 100 may be a radio terminal and the reception-side communication apparatus 200 may be a base station. Alternatively, instead of a base station, a relay station (a relay node) may be used.

In the aforementioned embodiment, the transmission-side communication apparatus 100 recognizes the reception state of the reception-side communication apparatus 200 through feedback from the reception-side communication apparatus 200. However, in the case of using a scheme (a TDD scheme) using the same frequency in transmission (for example, a downlink) from the transmission-side communication apparatus 100 to the reception-side communication apparatus 200 and transmission (for example, an uplink) from the reception-side communication apparatus 200 to the transmission-side communication apparatus 100, the transmission-side communication apparatus 100 may perform measurement for a reception signal from the reception-side communication apparatus 200 by using the reversibility of an uplink and a downlink, thereby recognizing the reception state of the reception-side communication apparatus 200.

In the aforementioned embodiment, the HARQ of the CC scheme is described. However, the present invention is not limited to the HARQ of the CC scheme, and may also be applied to the HARQ of a full incremental redundancy (FIR) scheme, a partial incremental redundancy (PIR) scheme and the like.

Thus, it should be understood that the present invention includes various embodiments, for example, that are not described herein.

In addition, the entire content of Japanese Patent Application No. 2011-088563 (filed on Apr. 12, 2011) is incorporated in the present specification by reference.

### INDUSTRIAL APPLICABILITY

As described above, since the transmission-side communication apparatus and the retransmission control method according to the present invention can use a modulation and coding scheme (MCS), which is different from that at the time of initial transmission, at the time of retransmission without a change in the configuration of a conventional reception-side communication apparatus, they are useful in a radio communication field.

1. A transmission-side communication apparatus, which transmits a packet to a reception-side communication apparatus in a radio communication system that supports adaptive modulation and coding and hybrid automatic retransmission control, comprising:
a transmission unit that transmits an initially transmitted packet and a retransmitted packet to the reception-side communication apparatus, the retransmitted packet being combined with the initially transmitted packet in the reception-side communication apparatus; and
a control unit that controls, when a modulation and coding scheme different from the modulation and coding scheme used at the time of transmission of the initially transmitted packet is used at the time of retransmission, the transmission unit to transmit, instead of transmitting the retransmitted packet, a new initially transmitted packet including retransmission data to be transmitted, by using the different modulation and coding scheme, through the retransmitted packet, to the reception-side communication apparatus.

2. The transmission-side communication apparatus according to claim 1, wherein
when the different modulation and coding scheme is used at the time of retransmission due to deterioration of a radio state between the transmission-side communication apparatus and the reception-side communication apparatus, the control unit controls the transmission unit to transmit, instead of transmitting the retransmitted packet, the new initially transmitted packet to the reception-side communication apparatus by using the different modulation and coding scheme.

3. The transmission-side communication apparatus according to claim 1, wherein
the transmission unit comprises:
a first retransmission queue unit that holds the retransmission data to be transmitted through the retransmitted packet;
a second retransmission queue unit; and
a transmission queue unit that holds data to be newly transmitted,
the control unit controls the transmission unit to include the retransmission data held in the first retransmission queue unit into the retransmitted packet and to transmit the retransmitted packet when a modulation and coding scheme, which is equal to the modulation and coding scheme used at the time of transmission of the initially transmitted packet, is used at the time of retransmission, and
the control unit moves the retransmission data held in the first retransmission queue unit to the second retransmission queue unit and then controls the transmission unit to include the retransmission data into the new initially transmitted packet in sequence of priority of retransmission data held in the second retransmission queue unit and data held in the transmission queue unit, to transmit the new initially transmitted packet when the different modulation and coding scheme is used at the time of retransmission.

4. A retransmission control method of a transmission-side communication apparatus, which transmits a packet to a reception-side communication apparatus in a radio communication system that supports adaptive modulation and coding and hybrid automatic retransmission control, comprising:
a step of transmitting an initially transmitted packet to the reception-side communication apparatus by using a first modulation and coding scheme; and
a step of transmitting a new initially transmitted packet to the reception-side communication apparatus by using a second modulation and coding scheme, instead of transmission of a retransmitted packet that is combined with the initially transmitted packet in the reception-side communication apparatus, when the second modulation and coding scheme different from the first modulation and coding scheme is used at the time of retransmission, the new initially transmitted packet including retransmission data to be transmitted through the retransmitted packet.

5. The retransmission control method according to claim 4, wherein,
in the step of transmitting the new initially transmitted packet, when the second modulation and coding scheme is used at the time of retransmission due to deterioration of a radio state between the transmission-side communication apparatus and the reception-side communication apparatus, the new initially transmitted packet is transmitted, instead of the retransmitted packet being transmitted, to the reception-side communication apparatus by using the second modulation and coding scheme.

6. The retransmission control method according to claim 4, wherein
the transmission-side communication apparatus comprises:
a first retransmission queue unit that holds the retransmission data to be transmitted through the retransmitted packet;
a second retransmission queue unit; and
a transmission queue unit that holds data to be newly transmitted, and
the step of transmitting the new initially transmitted packet comprises:
a step of moving the retransmission data held in the first retransmission queue unit to the second retransmission queue unit, and
a step of including the retransmission data into the new initially transmitted packet in sequence of priority of retransmission data held in the second retransmission queue unit and data held in the transmission queue unit.
